(19) United States
(12) Patent Application Publication
(10) Pub. No.: US 2015/0333826 A1
(43) Pub. Date: Nov. 19, 2015

(54) OPTICAL PATH CONTROL IN A NETWORK

(71) Applicant: INTUNE NETWORKS LIMITED, Dublin (IE)

(72) Inventors: Tom Farrell, Co. Dublin (IE); David Galbraith, Dublin (IE); Giuseppe Talli, Dublin (IE); Emilio Bravi, Dublin (IE)

(73) Assignee: INTUNE NETWORKS LIMITED, Dublin (IE)

(21) Appl. No.: 14/654,037

(22) PCT Filed: Dec. 21, 2013
(86) PCT No.: PCT/EP2013/077871

§ 371 Date: Jun. 19, 2015

Related U.S. Application Data
(60) Provisional application No. 61/740,621, filed on Dec. 21, 2012.

(30) Foreign Application Priority Data
Dec. 21, 2012 (EP) 12199128.5

(51) Int. Cl. H04B 10/079; H04Q 11/00

(52) U.S. Cl. CPC H04B 10/07955; H04Q 11/0066; H04B 10/0793; H04Q 2011/0083; H04Q 2011/0041

(57) ABSTRACT

A control system and method in an optical burst mode network, said network comprising a plurality of channels, at least one channel adapted to carry bursts of data from multiple sources, the control system is configured to calculate a per channel gain measurement from the acquisition of per source received burst data measurements at a channel termination point. The control system facilitates automated per channel optical power monitoring and equalisation without human intervention over the operational life span of the optical system.

### FIELD

The invention relates to optical path control in a network. In particular the invention relates to optical aging control in an optical burst system.

### BACKGROUND

A necessary requirement for any optical transmission system is for the Bit Error rate at any receiver in the system to be maintained at an acceptable level over the systems operational lifespan. The BER at any point in time can depend on a number of factors, one of which includes the Optical power level at the receiver.

In the design of an optical system much effort is placed on producing and analysing the optical power budget for all optical paths within the system, which involves calculating all optical signal losses and gains caused by every component in the optical path between each transmitter and receiver. The main objective is to ensure that the power of the optical signal at the receiver is greater than the sensitivity of the receiver. Often included in the Optical power budget there will be allowance made for changes in optical characteristics of components due to aging affects over the expected system operational timespan.

The mechanism outlined in this document, allows the magnitude of the aging component in a System Optical Budget to be reduced and constrained via active control and management of aging related degradation on a per channel basis. This allows much of the aging component margin to be re-allocated to other areas within the budget e.g. to transmitter power levels, span length, number of nodes etc to suite the requirements of the system.

There have been a number of approaches to addressing the issue of maintaining optical signal integrity over the life of an optical product.

The simplest approach relies solely on ensuring sufficient margin is built into the optical Budget to allow for worst case optical power variation over life. This can be sufficient for some system designs however it often places limiting constraints on other areas of the Optical Budget such as fibre length.

A second approach is for the manual maintenance adjustments of an Optical System over life. Operators may periodically obtain Optical performance information from measuring mechanisms within the system and then manually make adjustments to attenuation or gain elements on each optical path to bring power levels back to a pre-defined target. In DWDM Solutions, where often manual retuning is required both when channels/services are added/removed and also over the life of the product to adjust for aging related loses that develop over a longer time period, this can add delays and costs to supporting continued operation of the system.

An evolution of the manual maintenance method is to build automation into the process, which is currently offered by some suppliers in the telecoms industry. The level of control of the optical layer parameters via the automated process (and also the manual method) is in some ways dependent on the accuracy and ability to measure each optical path at each node in the system. Some solutions require measurement points for each channel in the system at each node (which adds extra cost depending on the number of channels the system is designed to provide, and also depending on the number of nodes or adjustment points available within the system). Other solutions instead use averaged measurements across all channels with the inevitable loss in accuracy. A passive optical system is disclosed by US2008/002973 (Yamababa Tetsuji) which discloses an optical power monitor for a PON telecommunication network.

These approaches while appropriate for a constant bit rate system, in that the monitored channel power is always on will operate correctly, but when a burst mode system is the underlying transmission means, the power is not always on and also there can be bursts from multiple sources on the same line that the monitor cannot differentiate between and as each has a different path on the system, each would require optimization of different optical components in their respective paths.

It is therefore an object of the invention to provide a control system and method for burst mode optical networks to mitigate against errors in the network.

### SUMMARY

According to the invention there is provided, as set out in the appended claims, a control system in an optical burst mode network, said network comprising a plurality of channels, at least one channel adapted to carry bursts of data from multiple sources, the control system is configured to calculate a per channel gain measurement from the acquisition of per source received burst data measurements at a channel termination point.

In one embodiment there is provided a control system in an optical burst mode network, said network comprising a plurality of segments; a plurality of channels; and at least one channel adapted to carry bursts of data from multiple sources, the control system is configured to calculate a per channel gain measurement per segment.

The invention relies on Power Monitoring capability at the termination point of each channel coupled with an ability to read the signal source, and is particularly suited to Optical switch applications where a channel termination point can receive signals from a number of different sources from within the system. The invention facilitates automated per channel optical power monitoring and equalisation without human intervention over the operational life span of the optical system.

The control system removes the need for more costly per channel monitoring capability at each node at each segment, instead moving this ability to the end point of each channel.

In one embodiment said calculation comprises a transmit laser power measurement.

In one embodiment there is provided means for measuring the power of each received burst and identifying the source of each burst; and means for associating the power measurement with the identified source.

In one embodiment there is provided means for calculating the channel gain by subtracting the received power of burst from a particular source from the measured source transmit power.

In one embodiment there is provided means for determining the gain on each segment for each channel by subtracting adjacent source gains from one another.

In one embodiment there is provided means for adjusting the gain of each channel in each segment.

In one embodiment there is provided means for comparing measured segment gain values for each segment in a channel against a set of desired or target gain values for each Gain Segment to produce a set of Gain Error values.

In one embodiment the set of gain error values are processed to provide a control function.

In one embodiment the output of the control function block comprises a set of adjustments that are applied at specific segments on at least one channel to mitigate the gain error values.

In one embodiment there is provided means for transmitting the channel gain measurement and measured receive power back to the source.

In one embodiment each source has a measure of the received power at all destinations that it can send a burst, and the source comprises means to optimize the transmit power such that the received power for all destinations are optimized.

In another embodiment there is provided A method of controlling an optical network, said network comprising a plurality of segments; a plurality of channels; and at least one channel adapted to carry bursts of data from multiple sources, the method comprising the step of calculating a per channel gain measurement per segment.

In one embodiment there is provided a filter applied to each per source/destination power measurement adapted to reject higher frequency power changes in the network such as transients in power. Transients can occur in optical amplifiers where the input power varies such that the gain or loss of the amplifier is not kept constant during the changing in input power to the amplifier. In typical EDFA (Erbium Doped Fibre Amplifiers) gain is proportional to the pump power divided by the input power and many control schemes are applied to control the pump power such that the gain of the edfa is constant with variations in input power. There still remains some transient gain which effects the burst power as is passes through the amplifier.

In one embodiment there is provided means for averaging Polarization dependent Loss (PDL) over a period of time such that PDL effects are not amplified in the network.

In a further embodiment there is provided a method of calculating the channel gain in an optical burst mode network, said network comprising a plurality of channels, at least one channel adapted to carry bursts of data from multiple sources, said method comprising the steps of:
identifying a source transmitting a burst of data;
measuring the transmit power from the source; and
calculating the channel gain by subtracting the received power of burst from a particular source from the measured source transmit power.

In another embodiment there is provided a system for calculating the channel gain in an optical burst mode network, said network comprising a plurality of channels, at least one channel adapted to carry bursts of data from multiple sources, said system comprising
means for identifying a source transmitting a burst of data;
means for measuring the transmit power from the source; and
means for calculating the channel gain by subtracting the received power of burst from a particular source from the measured source transmit power.

In one embodiment the use of a common receiver in each source/destination measurement helps to minimize the statistical spread of measurement error helping to reduce the spread in uncertainty with this mechanism. This translates into tighter operational windows within which the aging effects can be constrained, helping to free up parts of the optical budget.

In one embodiment the control system is adapted to be tolerant of transmit laser power variation, as transmit power measurements are included in the calculation. This implies that the control can be applied to system configurations which may control transmit laser power through mechanisms not connected to this segment gain controller.

It will be appreciated that by monitoring received powers at the end point, it is possible to layer per channel fault detection and performance mechanisms on top of the basic per source power monitoring function. For instance it is possible to provide sufficient granularity to identify the segment or source which is presenting an issue to the system and which needs user intervention giving layer 1 visibility into faults, power levels and performance, on a per channel basis.

An advantage of the present invention is that the control system is is fully automatic, no truck rolls or maintenance windows are required to maintain the optical layer in the presence of component aging or when new services are brought on line.

There is also provided a computer program comprising program instructions for causing a computer program to carry out the above method which may be embodied on a record medium, carrier signal or read-only memory.

### BRIEF DESCRIPTION OF THE DRAWINGS

The invention will be more clearly understood from the following description of an embodiment thereof, given by way of example only, with reference to the accompanying drawings, in which:—

FIG. 1 illustrates a prior art implementation of an optical burst switched communication network;

FIG. 2 illustrates a control Loop of the Aging Control system according to one embodiment of the invention;

FIG. 3 illustrates an example architecture of a data packet for use in an optical burst system or network;

FIG. 4 illustrates an example of a plurality of nodes in an optical network in more detail; and

FIG. 5 illustrates a number of nodes arranged in series in an optical network.

### DETAILED DESCRIPTION OF THE DRAWINGS

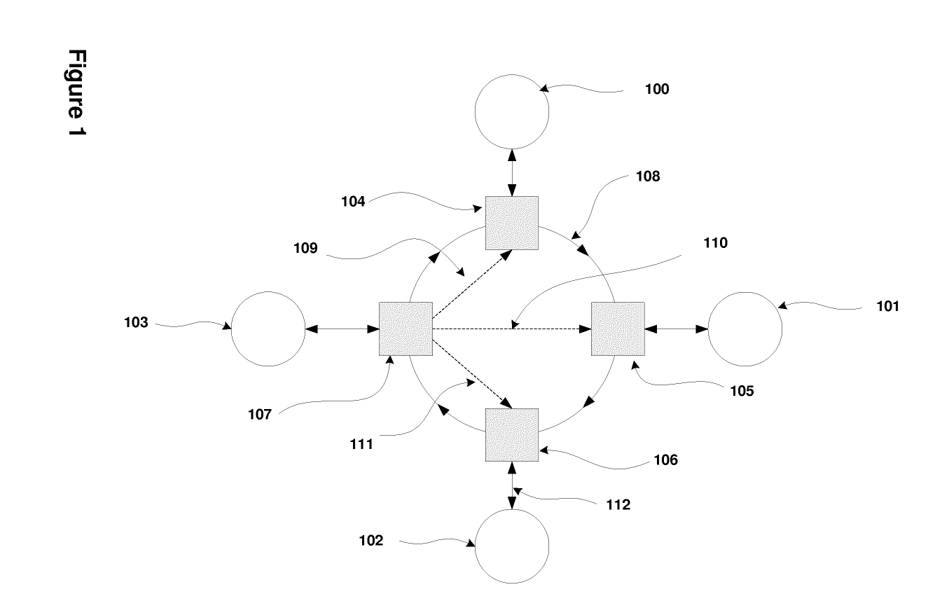

A burst mode optical network can be seen as a series of coupled segments arranged in either a ring or linear topology in which it is possible to create multiple sourced channels that transmit to a multiple end points in the network. An example of a known optical ring communication network architecture is shown in FIG. 1 comprising a number of external network interfaces 100, 101, 102, 103 connected to a number of ports 104, 105, 106 and 107, where these preferably contain a fast tunable laser which is wavelength switched to address a given destination port, arranged in the ring network. The ports 104, 105, 106 and 107 are connected by a physical optical path link 108, for example using an optical fibre, in a clockwise fashion from transmitter to receiver. Each of the ports 104, 105, 106 and 107 can communicate with each other over wavelength addressed optical channels. By way of example, paths 109, 110 and 111 are the paths or segments set up between 107 to 104; 107 to 105; and 107 to 106 on the basis of different burst wavelengths or channels transmitted from a fast tunable laser, present in 107. PCT patent publication number WO2011/058135, assigned to the same applicant as the present invention, describes a ring network topology in more detail and is incorporated herein fully by reference.

The gain of each channel in each segment must be controlled to a set target to ensure correct system operation over life. The target gains can be static, provided from a once off calculation or can change over life if required to reflect more optimal distribution of gain based on changing system characteristics over time. For instance, the gain calculation can be based on the automatic measured losses obtained using an Optical supervisory channel. In general the control can be applied to apply a suite of rules particular to the system for the setting of each channel gain in each node segment, e.g. in burst mode systems utilizing edfas, each data channel may be configured to maintain a set offset from the power of the supervisory channel which is required for optimal edfa stability in the presence of burst transmission. By having a supervisory channel the max to min variation in input power to the edfa can be minimized, for example if the supervisory channel has the same power as 10 data channels, the max to min input power is 10 data channels of power to 10 plus the number of data channels versus going from 0 to the number of data channels. This has a very advantageous effect on the transient gain of the edfa during input power variations which are typical of an optical burst transmission system.

At each termination point in the system, the power of each received burst is measured and the source of each burst is discovered and associated with the measurement. In this way it is possible to produce a continuous series of power measurements on a per source/destination basis. Filters can be applied to each per source/destination power measurement to reject higher frequency power changes in each trail if required.

In parallel with the received power measurements, it is also necessary to acquire transmit power measurements from each source in the system—this is the case for systems where the TX power may not be guaranteed and fixed over life. It is possible to calculate the total gain of each source/destination path by subtracting the Received power of the bursts from a particular source from the actual Source transmit power.

Once the gain is known for each trail on a particular channel, it is then possible to determine the gain on each segment for each channel, by subtracting adjacent source/destination trail gains from one another, and subsequently the deviation of this measured segment gain from the target gain can be calculated.

Adjustments can be made to the gain of each channel in each segment using methods appropriate to the system. For instance, gain adjustments can be made to using per channel voa elements in each node. Common mode adjustments can be made to alternative components if available, such as an optical attenuation which changes the attenuation of all wavelengths equally, also this can be controlled by a supervisory channel which is transmitted across each segment of a path. The PDL on this path is also much smaller as it is typically terminated and retransmitted in each node thereby PDL does not accumulate on this channel. Alternatively the gain in the optical amplifiers can be modified to increase or decreases the optical gain to achieve the same effect.

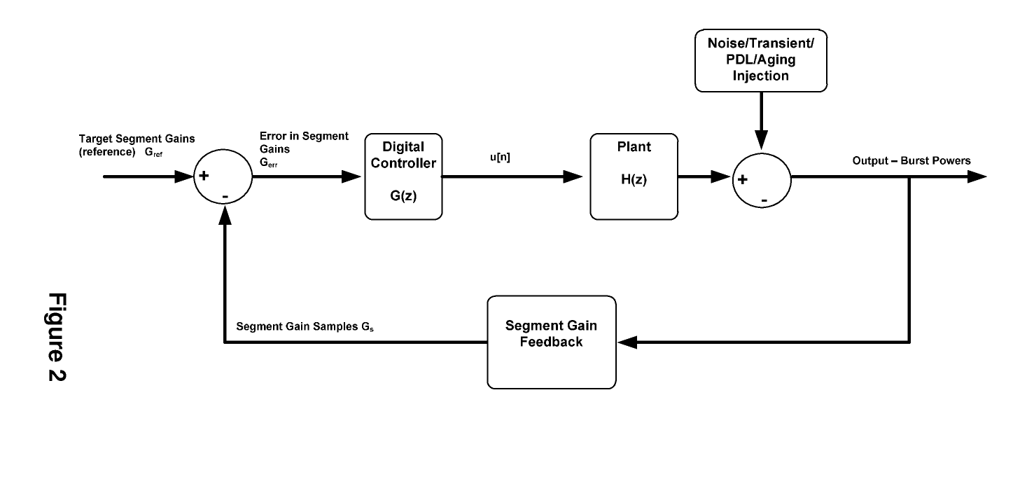

FIG. 2 illustrates a Segment Gain Control mechanism shown as a Digital Segment Gain control loop according to one embodiment of the invention. As a starting point, the Power of the Received bursts is regularly sampled and measured and passed into the feedback section of the control loop.

Through a feedback conversion process, the RX burst source/destination powers are converted into Measured Segment Gain values for each segment in the system. The Measured Segment Gain values are compared against a set of desired or target gain values for each Gain Segment to produce a set of Gain Error values, which describe for that sample how far the measured gain is from the desired. The Segment Gain Error values are then passed as input into a Segment Gain Controller Function, which operates on the principle of trying to minimise the Segment Gain Error. The output of the control function block is a set of adjustments that must be made at specific places within the system and on specific channels during the current sample window.

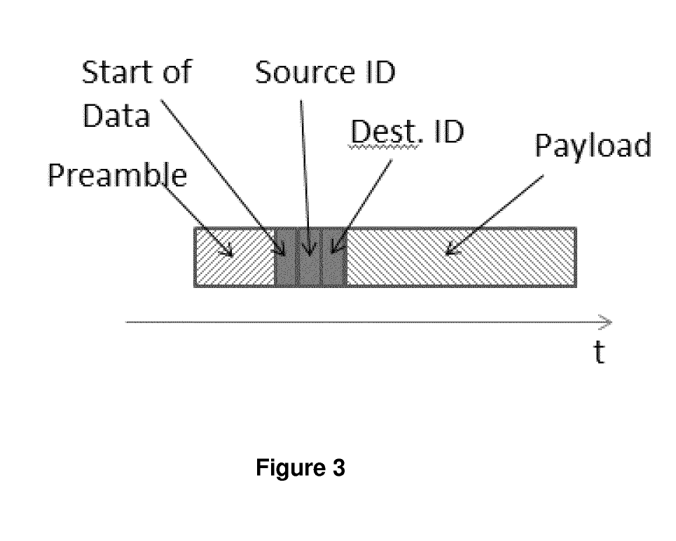

The invention provides a means for measuring the power of each received burst and identifying the source of each burst; and means for associating the power measurement with the identified source. FIG. 3 shows a structure of a burst of data in an optical burst mode network comprising a preamble or start of burst (SOB), a start of data (SOD) section, a source ID, destination ID and a payload containing the data to be transmitted. The control system of FIG. 2 is configured to identify burst measure burst power and source identifier at a burst mode receiver. At an end point in the system, the receive block performs an optical to electrical conversion, locking onto the preamble sequence to allow clock extraction and data recovery. Once the receive block has found the SoD, the Burst Header (BH) is inspected to read the Source and Destination Id's. Basic checks can be performed to ensure that the DesID matches the intended end point to ensure that the burst was not received in error, and then the burst can be subsequently processed according to its source ID (SrID). The Receive Block is also capable of performing burst power measurements using high speed sampling mechanisms on each incoming burst, allowing an average value across the burst envelope to be determined. The Power measurement value is then aligned, in real time, with the SrID of the associated burst, and the power measurement is Binned according to its Source ID. In this way, each end point in the system can maintain Burst Receive Power Statistics for each Source ID active in the system, in particular, Averaged Received Power per source, Receive Burst Counts, Maximum Receive Burst Power and Minimum received Burst Power. The Receive Block construction allows for all per source statistics to be updated upon the arrival of each new burst and the contents of each bin are made available to any function within the system that requires them.

The control system of FIG. 2 can be configured to measure transmit power. The System allows for averaged power measurements to be made at the points in the system where the Source Bursts are physically coupled and inserted into the main ring. The Transmit Power measurements can be made available to any function operating within the system that requires them. During periods where there is no client traffic to transmit on any wavelength, the source laser is switched to a dedicated wavelength reserved in the system for use during these “quiet” periods, referred to simply as the “Off Channel”. In this way, the majority of time there is always an optical signal being transmitted from the source apart from the necessary guard times between individual bursts. This scheme allows for simplification in the transmit power measurement mechanisms at the coupling point to the main ring, allowing the use of lower speed power sampling circuitry as the transmit power measurement block now does not have to be capable of measuring each individual burst. Alternatively the transmit power can be measured in the same way as described for the receive burst and binned according to destination and hence have a transmit power per destination rather than an average one for all destinations.

It will be appreciated that the control loop can use an idealised matrix form to represent the information and process the information.

The control scheme as described can be operated in an AGC (Automatic gain control) or APC (automatic power control) mode.

In AGC mode the intent is to have the gain of each part of the path a burst will pass through optimised, typically for zero gain where the loss is equal to the gain. In this way the net effect of any burst travelling through the network will be such that it will arrive at the receiver with the same power as it was transmitted at and thus remove any variations in the transmission network. This is advantageous in the respect that irrespective of the launch power the network can be optimised for many sources at different entry points and exit points on the network as in a burst switching optically routed network. In this approach gains should be used where the gain is the net difference in launch to receive power across a path.

In APC mode the intent is to set up the network such that the receive power is equal for all sources. This optimises the network to minimise any receiver penalty due to differential power receives and can be important in burst networks to reduce the power difference between sequential bursts. In this case each path can be adjusted separately. If the launch powers of each source at different entry points to the network are different this can cause imbalances in the power of bursts as they progress through the network at a cost of OSNR, but can reduce any penalty due to inter-burst power differentials. Alternatively an additional control can be placed on the transmit side to ensure all receive powers are equal and this can be run in tandem with the above control scheme so that the APC scheme can deliver an AGC like performance while also reducing the inter burst power differential received power level.

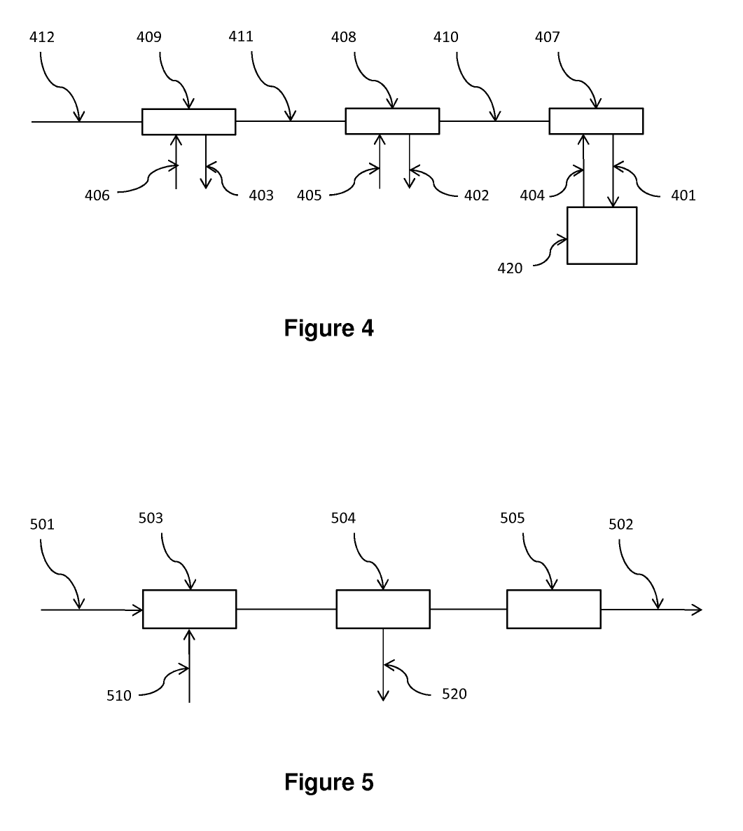

FIG. 4 shows a number of nodes (407,408,409) which are interconnected by fibre optic spans or optic cable (410,411,412) and can be such that the connection of the nodes with fibre optic spans creates an optical ring. In each node there are a number of adds (404,405,406) and drops (401, 402, 403). Each drop and add is connected to typically an optical transponder (420) which contains a laser and optical receiver to generate optical signals to add to the node and receive optical signals received. Each drop (401, 402, 403) is a specific wavelength for that node and is typically not reused in a fibre optic ring, so that any port can be addressed by any add by selecting the correct wavelength for transmission. The transponders typically contain a fast switching tunable laser such that bursts of information can be transmitted at a predetermined wavelength such that the information for any particular drop/node can be selected by such.

In the case of the drop 401, it will receive bursts of data from all sources/adds (404,405,406) and will measure the per source burst power received. In this example each source starting from the closest to the drop (401) progressively add further distance but importantly for some portion of the path from the add to the drop it will traverse the path used by other adds, i.e. add 405 includes the node 408,407 and fibre span 410, which add 404 includes node 407 only. In this way it is possible to decouple the variations in received power monitored by 420 for each source, such that the effective net gain/loss of each span can be monitored and adjusted if such means are available.

The basic components of a node are shown in FIG. 5. The ingress 501 and egress 502 are optical fibre inputs and outputs to the node which typically connect to fibre spans to interconnect such nodes. 503 is the mechanism for adding an input (510) to the node and is typically implemented with a fibre optic coupler. The drop function is implemented by 504, where a specific wavelength is dropped from the input to port 520 while all other inputs are directed towards 505. This is typically implemented with a wavelength selective switch and allows attenuation of each wavelength independently. Optical amplification is shown in 505 where the signal amplitude is amplified with a Raman, EDFA, SOA or other such optical amplifier.

The wavelength selective switch in 504 allows means for each node to optimise the signal levels of all wavelengths and occurs at each node so that each span can be optimised independently of the others.

It is also possible to have a system where each receiver detects the input power of all bursts and sorts them according to source node as above, but then transmits the measured value back to the source, such that each source has a measure of the received power at all destinations that it can send a burst. In this way the local node can then optimize its power added to the fiber such that the received power for all destinations are optimized. If all nodes in the system have a source and they all operate in the same way, every path in the system will be optimized.

There are other approaches such as means to ensure that one change in a path loss, that effects all other paths through that segment do not cause a cascade of shifts. This needs careful attention to ensure the system is stable. This is particularly important in systems with a large number of segments in the longest path. It is possible for some error conditions that when applying adjustments that the longest paths optical performance may decrease and data can be lost before the full set of adjustments to all paths are applied. This can be performed by applying the corrections to each segment of the longest path in an order which ensures that the longest paths performance always improves or at least stays within an acceptable range. A typical method to perform this is to apply the corrections over multiple stages such that at any time during the first stage the performance is improved for all paths, then applying a subsequent stage. Alternatively they can be applied in multiple stages with a small adjustment size applied to each path, and repeat until the full correction has been applied.

In another embodiment the system can be optimized for OSNR, particularly the PDL contribution to OSNR as for each path in the system it will experience a different level of PDL, such that a single measurement corresponds to a path, whereas another measurement may correspond to a part of that path, or a larger path of which the previous one is a subset or partial subset. In this scenario, it may not be advantageous to decouple all parts of the path such that individual parts of the path are monitored by different paths. An overall average of all the paths is better to minimize the effects of OSNR on the worst paths.

PDL (Polarization dependent Loss) is an impairment that occurs in most optical systems. PDL causes variations in the loss of power in fibre and components depending on the input polarisation. Generally the variation of PDL with time is slow but can become fast in several cases, such as fibre vibration or many optical components with PDL in the path. In a control scheme to optimise the network gains and receiver powers, PDL will add variable losses to each independent path through the system and can cause significant variations. One way to reduce the effect of PDL is for a control scheme to average out the effect, by taking a long period to measure the receiver powers over, such as hours to days. Over this period taken the PDL should vary such that a good mean of the PDL is obtained in the average burst power measurement per source, which means the network will then be optimised for the mean PDL in the system, rather than following the PDL. In this way the PDL penalty is fixed and the control scheme does not amplify the effects of PDL.

In installation the control scheme can run more frequently or with a faster time constant that the period needed for PDL removal, to remove any initial errors in the paths which can be significant and greater than the PDL error in any case, and they switch or move gradually to a longer time period to remove the PDL from the control loop. In this way the system is optimised using a closed loop control for each optical burst path through the system, i.e. the performance of each source to destination is directly controlled from the transmitter (laser) direct to the receiver.

In addition the control system may link the control of each wavelength such that there is a very slow control loop operating on each individual wavelength and a faster control operating on the grouping of multiple wavelengths, and example of such a grouping would be to manage the tilt of the wavelength spectrum rather than each individual wavelength independently. This has the advantage of providing further isolation of the system from PDL and other noise sources which affect the burst receive power. In installation the part of the control operating on each individual wavelength can be made to operate in a fast mode and initially reduce any initial error in the system and then proceed to a slow control to only consider tilt of the spectrum.

It will be appreciated that the control system can be configured with traffic awareness functionality in the network. In some cases the net gain of a path is dependent on the input power and wavelengths. An example of this is Spectral Hole Burning (SHB) where the gain of an EDFA at a particular wavelength is dependent on the depth of the hole which is determined by the amount of optical power present in a small wavelength range about that wavelength. This effect is strongest at short wavelengths and depends typically on the range of 1 to 4 nm about the wavelength being measured. In this case the control scheme will follow such variations in gain to achieve the correct gain or receiver power, but in a burst system the traffic can change instantly if the amount of traffic to be transmitted stops or jumps which is typical in burst data applications. In such a scenario the control scheme can use additional data already gathered which is the number of bursts received from each source to determine the amount of optical power and wavelength transiting any path in the system. The power is proportional to the number of bursts time length divided by the total measurement time. In this way with a priori knowledge of the effect it can be removed from the control loop by adjusting the target depending on the loading and hence the control loop will not follow this effect.

In general the control loop following effects which can be slower and sometimes faster is a problem, for example in the above case where the traffic is low, the input light to any edfas is low and the control loop will adjust all the gains to optimal conditions. If within a short space of time the traffic load increases to maximum the gains in all edfas will drop due to SHB and hence the system will see a drop in all receiver power which will give rise to a penalty in the system. If the system then stays at this condition for longer than the bandwidth of the control loop, gains will be readjusted back to optimal conditions. Then if the traffic switches back to light loaded conditions a positive error is obtained. The size of the error in both conditions is approximately equal to the error obtained if the control loop rejected these effects though knowledge of the loading of the edfa. The difference is that the error can now be obtained in a positive and negative direction which leads to twice the error in the full running system with the control loop not rejecting these effects. By making the control loop ‘aware’ of the loading of the system and knowledge of the effects of loading the penalties due to this effect can be halved from the case where the control loop is ‘unaware’ of the traffic loading.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A control system in an optical burst mode network, said network comprising a plurality of segments; a plurality of channels; and at least one channel adapted to carry bursts of data from multiple sources, the control system is configured to calculate a per channel gain measurement per segment.

2. The control system of claim 1 comprising a module for determining the gain on each segment for each channel by subtracting adjacent source gains from one another.

3. The control system of claim 1 comprising a module for determining the gain on each segment for each channel by subtracting adjacent source gains from one another and adjusting the gain of each channel in each segment.

4. The control system of claim 1 comprising a module for comparing measured segment gain values for each segment in a channel against a set of desired or target gain values for each Gain Segment to produce a set of Gain Error values.

5. The control system of claim 4 wherein the set of gain error values are processed to provide a control function.

6. The control system of claim 4 wherein the set of gain error values are processed to provide a control function and the output of the control function block comprises a set of adjustments that are applied at specific segments on at least one channel to mitigate the gain error values.

7. The control system of claim 1 comprising a module for calculating the per channel gain measurement for a group of segments.

8. The control system of claim 1 comprising a module for identifying each source.

9. The control system of claim 1 wherein said calculation comprises a transmit laser power measurement.

10. The control system of claim 1 comprising a module for measuring the power of each received burst and identifying the source of each burst; and for associating the power measurement with the identified source.

11. The control system of claim 1 comprising means for calculating the channel gain by subtracting the received power of burst from a particular source from the measured source transmit power.

12. The control system of claim 1 comprising means for transmitting the channel gain measurement and measured receive power back to the source.

13. The control system as claimed in claim 1 wherein each source has a measure of the received power at all destinations that it can send a burst, and the source is adapted to optimize the transmit power such that the received power for all destinations are optimized.

14. The control system of claim 1 comprising a filter applied to each per source/destination power measurement adapted to reject higher frequency power changes in the network.

15. The control system of claim 1 comprising means for averaging Polarization dependent Loss (PDL) over a period of time such that PDL effects are not amplified in the network.

16. A method of controlling an optical network, said network comprising a plurality of segments; a plurality of channels; and at least one channel adapted to carry bursts of data from multiple sources, the method comprising the step of calculating a per channel gain measurement per segment.

17. The method of claim 16 comprising the further step of determining the gain on each segment for each channel by subtracting adjacent source gains from one another.

18. (canceled)

19. (canceled)

20. The method of claim 16 comprising the step of calculating the per channel gain measurement for a group of segments.

21. A computer program comprising program instructions for causing a computer to perform the method of claim 1.

22. (canceled)

23. A method of calculating the channel gain in an optical burst mode network, said network comprising a plurality of channels, at least one channel adapted to carry bursts of data from multiple sources, said method comprising the steps of:
identifying a source transmitting a burst of data;
measuring the transmit power from the source; and
calculating the channel gain by subtracting the received power of burst from a particular source from the measured source transmit power.
